(19) United States
(12) Patent Application Publication
(10) Pub. No.: US 2020/0410455 A1
(43) Pub. Date: Dec. 31, 2020

(54) Peer-to-Peer Tutoring

(71) Applicants: Matias J. Aviñó, Coral Gables, FL (US); Lourdes R. Aviñó, Coral Gables, FL (US)

(72) Inventors: Matias J. Aviñó, Coral Gables, FL (US); Lourdes R. Aviñó, Coral Gables, FL (US)

(21) Appl. No.: 16/914,610

(22) Filed: Jun. 29, 2020

Related U.S. Application Data
(60) Provisional application No. 62/867,625, filed on Jun. 27, 2019.

(51) Int. Cl. G06Q 10/10; G06Q 50/20; G06Q 50/00; H04L 29/06; G09B 5/06; H04L 12/58; H04W 4/02; H04N 7/15

(52) U.S. Cl. CPC G06Q 10/1095; G06Q 50/2053; G06Q 50/01; G06Q 10/10; G06Q 10/1091; G09B 19/06; G09B 5/065; H04L 51/046; H04W 4/023; H04N 7/15; H04L 63/10

(57) ABSTRACT

A system to match students with tutors in a closed network includes: an electronic communications network, a school domain accessible via the electronic communications network, and a peer-to-peer tutoring application.

### CROSS-REFERENCE TO RELATED APPLICATIONS

This application is a non-provisional of, and claims priority to, provisional patent application No. 62/867,625, filed on Jun. 27, 2019, titled “Peer-to-Peer Tutoring,” which is incorporated by reference herein.

### FIELD OF THE INVENTION

The invention disclosed broadly relates to the field of software applications, and more particularly relates to a method, apparatus, and system that provides a technological improvement to the way computers operate with respect to enabling, tracking, and/or scheduling peer-to-peer tutoring.

### BACKGROUND OF THE INVENTION

Many students benefit from tutoring. Schools recognize this and often provide tutoring services to students who are struggling. Public schools in particular will sometimes offer tutoring services to students enrolled in English as a Second Language (ESOL) programs. However, schools find it difficult to pay teachers to stay after hours or employ private tutors to assist students in understanding course material.

Then there are those students who are not struggling, but wish to improve their grades, earn college credit, or learn something new. Tutoring can benefit these students, but they often fall through the cracks because tutoring is earmarked for struggling students only. One possible solution is for parents to hire private tutors or drive their children to after-school learning centers, but both of these options are expensive and difficult to schedule. Working parents are not always available to drive their child to a tutor after school when tutors are available. The tutors themselves are not vetted by the school.

Peer-to-peer tutoring has been gaining some favor because it is a less expensive alternative to private tutors or after-school learning centers. This type of tutoring appeals to students from middle school all the way through university level because they receive instruction from their own peers. Some universities implement online programs for peer-to-peer tutoring.

### SUMMARY

In view of the foregoing, a system to match students with tutors in a closed network includes: an electronic communications network; a school domain configured to be accessible via the electronic communications network and secured to allow only authorized users; and a peer-to-peer tutoring application, the operation of which is limited within the school domain.

A computer-implemented method to facilitate peer-to-peer tutoring within a closed network includes steps or acts of: providing a peer-to-peer tutoring application with a graphical user interface on a client device of a student; receiving a search request from the student for a specific subject of instruction for a specific grade level; returning results including a profile of at least one tutor that has been pre-qualified in the specific subject of instruction; receiving from the student a selection of the tutor; monitoring a chat between the student and the tutor; monitoring each interaction between the student and the tutor; notifying the student's parent/guardian of each tutoring event; recording start and stop times of the tutoring session; and sending a report about the tutoring session to an administrator of the closed network.

### BRIEF DESCRIPTION OF THE DRAWINGS

In the accompanying figures, like reference numerals refer to identical or functionally similar elements throughout the separate views. The accompanying figures, together with the detailed description below are incorporated in and form part of the specification and serve to further illustrate various embodiments and to explain various principles and advantages all in accordance with the present invention, in which:

FIG. 1 shows an example of a landing page for a Tutor Match application (app);

FIG. 2 shows a tutorial page for the Tutor Match app;

FIG. 3 shows the registration page for the student;

FIG. 4 shows a dropdown menu for selecting a domain/school partnered with the Tutor Match program;

FIG. 5 shows a lessons page where the student is directed once the student activates the account;

FIG. 6 shows a Find a Tutor page;

FIG. 7 shows a list of tutors for the selected subject;

FIG. 8 shows a tutor profile page;

FIG. 9 shows a Request a Lesson page;

FIG. 10 shows a page for selecting the length of a session;

FIG. 11 shows the pop up displayed after requesting a session;

FIG. 12 shows a tutor's schedule;

FIG. 13 shows a tutor's approval email;

FIG. 14 shows a tutor's approval in the app;

FIG. 15 shows the timer countdown at the start of a session;

FIG. 16 shows the timer countdown at the end of a session;

FIG. 17 shows a Session Completed message;

FIG. 18 shows the tutor acceptance of a session;

FIG. 19 shows a pop up for starting a session;

FIG. 20 shows a session countdown that the tutor sees;

FIG. 21 shows the Session Completed message seen by the tutor;

FIG. 22 shoes the completed session email confirmation to the tutor;

FIG. 23 shows a tutor declining a session request;

FIG. 24 shows the screen for requesting a session at a later time;

FIG. 25 shows a Pending Approval status for a later-scheduled session;

FIG. 26 shows a Session Ready to Begin Email to Student for a later-scheduled session;

FIG. 27 shows a start lesson pop up for a later-scheduled session;

FIG. 28 shows a tutor request email sent to a tutor;

FIG. 29 shows a pop up requesting a tutor;

FIG. 30 shows a profile page;

FIG. 31 shows a Why Tutor page;

FIG. 32 shows an initial page for becoming a tutor;

FIG. 33 shows a monitoring message before a Chat with tutor;

FIG. 34 shows additional buttons for selection on a chat page;

FIG. 35 shows an email asking the student to rate the tutor;

FIG. 36 is a high-level operational flow diagram of a computer-implemented method for matching a student with a tutor, according to an embodiment;

FIG. 37 is a high-level illustration depicting the system for peer-to-peer tutoring, according to an embodiment;

FIG. 38 shows a high-level simplified block diagram of the components of a mobile device, according to an embodiment; and

FIG. 39 is an illustration of the server infrastructure, according to an embodiment.

### DETAILED DESCRIPTION

In the Description below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or can contain not only components A, B, and C, but also one or more other components or structures.

Any element in a claim that does not explicitly state “means for” performing a specified function, or “step for” performing a specific function, is not to be interpreted as a “means” or “step” clause as specified in 35 U.S.C. § 112, ¶6. In particular, the use of “step of” in the claims herein is not intended to invoke the provisions of 35 U.S.C. § 112, ¶6.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. Specifically, component names, types, and values, as depicted in the exemplary schematic diagrams, are not intended to limit the scope of the present invention and are presented only as possible embodiments.

In this specification and in the appended drawings, words and phrases have the meanings commonly attributed to them in the relevant art except as otherwise specified herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

Peer-to-Peer Tutoring Application.

While the invention is disclosed herein in the context of a method, system, tool, and service leveraging mobile device technology to facilitate peer-to-peer tutoring, it is within the scope of the invention disclosed that the method for implementing the peer-to-peer tutoring may also be used in other contexts, such as, but not limited to, other software application-enabled systems facilitating the matching of skills with needs.

The peer-to-peer tutoring application (app) is a budget-friendly, user-friendly and safe alternative to expensive tutoring as is traditionally known, enabling the matching of students with tutors, and facilitating the process for a student becoming a tutor. The peer-to-peer tutoring application not only assists with academic subjects, but allows students to receive tutoring in extracurricular activities such as learning to play a musical instrument or learning a foreign language. Furthermore, the application uses technology to foster learning with social connections and encourage positive relationships and camaraderie within its student body. The peer-to-peer tutoring application is an educational app to connect students with other students at school for the purpose of tutoring. It is a user-friendly application than can easily identify what tutor is available for tutoring; or conversely, who may need tutoring. A tutor, or prospective tutor, “checks in” when he/she is available for tutoring. The application identifies students/tutors who are in the same or near location, using their mobile phones, school-provided tablets, or similar computing devices.

Implementation.

In one embodiment, the peer-to-peer tutoring application is licensed to individual schools to provide a safe, controlled platform for students to meet with other students within their school to either find a tutor, be a tutor, or both. As such, embodiments of the invention contemplate facilitating peer-to-peer tutoring within a closed network.

The sessions can be in-person tutoring sessions where the student and tutor are face to face, or they can be distance learning sessions using video conferencing technology employed in applications such as FaceTime® by Apple, Inc., Skype® by Skype Communications S.a.r.l, and Zoom™ by Zoom Video Communications, Inc., to name a few. The distance learning paradigm allows for the tutoring program to reach students in other countries or in remote areas, who do not have means or opportunities for direct educational support.

The peer-to-peer tutoring application can be licensed to individual schools and provide students with a platform to meet with other students within their school to either find a tutor, be a tutor, or both. Currently, there are universities such as the University of North Carolina (UNC) that feature an online program of peer-to-peer tutoring for college credit. In addition, it is envisioned that users of the peer-to-peer tutoring application can sign up to tutor for community service hours. In return for providing tutoring to a student, the tutor receives community service hours for their time. A log is emailed to the tutor and then sent to the administrator at the school who records the community service hours for the students. The program might confer hours for tutoring under-privileged students, perhaps in other countries, thus extending the educational reach beyond the tutor's school.

Private Network.

The embodiments disclosed herein describe a mobile application for facilitating peer-to-peer tutoring within a closed, or private, network, such as a school. Unlike some popular apps that match skills with needs in an “open environment,” such as Angie's List, the peer-to-peer tutoring application is configured to operate within the confines of a “closed environment,” whereby the application, itself, controls every aspect of the student-tutor interaction and restricts the available participants within the context of a registered school and/or organization. In this way, the application, and the app-enabled system, enables the school/organization to carefully schedule and monitor the tutoring sessions. Parents are kept apprised of all session activity, from the scheduling of a session to the completion of a session.

Student/Tutor Profile.

In one embodiment, the tutors are students at the school who have completed sufficient coursework in a subject to be able to qualify as a tutor. The tutors themselves can also be tutored. The school approves a student for tutoring in a particular subject (for a particular grade). Once qualified, the peer-to-peer tutoring app accesses the school's database to retrieve information for the qualified tutor, such as the school photo and email, and creates a tutor profile. The qualified tutor is designated to be a tutor only for the subjects for which he/she has qualified. Those subjects are then associated with tutor in the profile. The tutor will then post his/her availability for tutoring (“hours”) on the profile.

A student registers for the peer-to-peer tutoring app and is then able to access the tutor's profile data. Student data will be stored on a Content Management System (CMS), a module/engine of the invention, once the student registers through the app. The school (domain) will have administrative control over the CMS and will have the ability to deactivate the student's account. The school monitors every interaction between the student and tutor via the app. The school is able to view and monitor all chats between the student and the tutor. The parent/guardian of the student is notified of every tutoring event.

Mobile Device Feature Integration.

It is contemplated that the peer-to-peer tutoring application will be implemented as a mobile application (app), according to an embodiment of the present disclosure. A mobile app is a software program that a user downloads onto a mobile device. In one embodiment, the mobile app is accessed directly from the mobile device, perhaps by selecting the mobile app icon associated with the app. Currently there are two types of mobile apps, native apps and mobile cloud apps. A native app is installed directly on the mobile device and different versions are often made, dependent on the mobile device developer. For example, many people today are very familiar with Apple® apps for iPhone®, as well as Android® apps for Samsung® phones. Data associated with a native app can be stored in the device or stored remotely and accessed by the native app. Because native apps use device-specific hardware and software, they are able to interact with in-device features and apps such as a global positioning system (GPS), short messaging service (SMS) app, sound, and a built-in camera.

The peer-to-peer tutoring application can interact with other mobile apps and in-device features such as SMS, GPS, sound, camera, tape recorder, and the like. One of the elements of the peer-to-peer tutoring application, whether embodied as a mobile app or otherwise, is a chat feature which leverages messaging technology available on mobile devices to send and receive messages.

One with knowledge in the art will appreciate that the “buttons,” “pop-up windows,” slider bars, and other GUIs depicted in the drawings are exemplary representations of user interaction tools and are not meant to be limiting in any way. In certain embodiments, the peer-to-peer tutoring application will feature alternative user interaction tools and still remain within the spirit and scope of the disclosure.

Mobile App Screens.

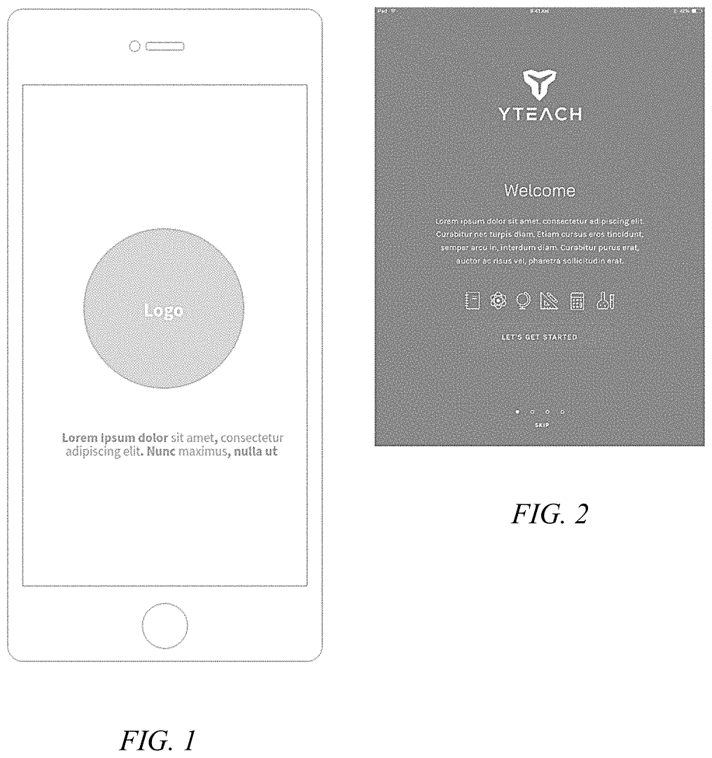

In view of the foregoing, a preferred embodiment of the present invention is directed to a peer-to-peer tutoring app that matches a student with a tutor. Referring now to the drawings in general, and to FIG. 1 in particular, there is shown a landing page for the peer-to-peer tutoring application, according to an embodiment.

FIG. 2 shows an example of a tutorial page for the peer-to-peer tutoring app. Tutorial pages include the following information: 1) an introduction to the app; 2) steps to setting up a lesson; and a message directed to a student whose school is not participating in the tutoring program and providing an option of how to get their school to participate. The steps to setting up a lesson are: 1) search a subject; 2) select and message a tutor; and 3) schedule lesson.

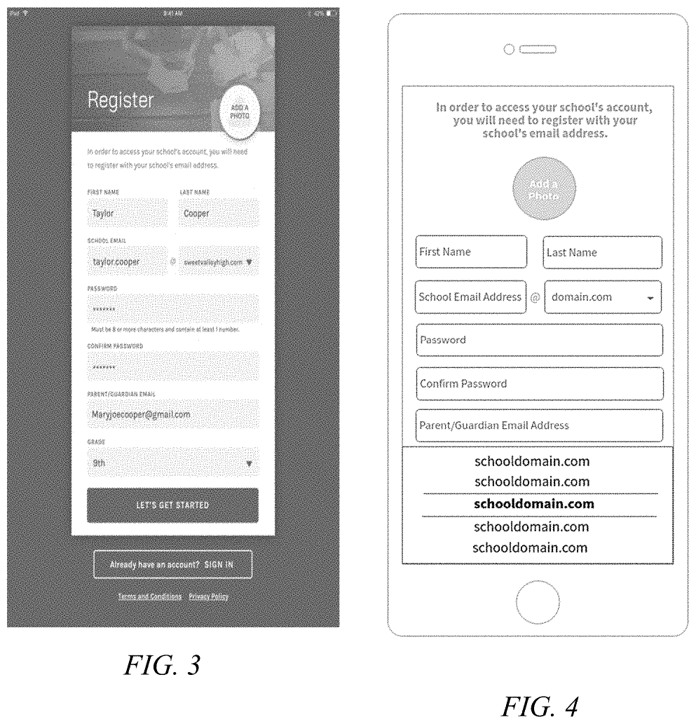

FIG. 3 shows an example of a registration page for a student to register with the program. Once the student's account has expired, the student will not be able to log into the account unless the student renews the account. An email is sent to the student's email address for authentication to ensure the student is still attending the school. Student data is stored on the CMS once the student registers through the app. The school has the ability to deactivate the student's account. Classes (Name and Email address) will need to be added manually by admin. The admin will have the ability to approve or reject a tutor. School has the ability to view chats. CMS will include all lessons for students/tutors.

FIG. 4 shows an example of a dropdown menu for selecting a domain/school that is partnered with the program. A verification email will be sent to the student to ensure the submitted email is valid and that the student is still enrolled at the school. The student must activate their account on the app. Check-in can be required in order to interact with other registered users through the app. Once activated, the app will direct the user to the lessons page. Parents/Guardians will receive an email notifying them their child has joined the tutoring program at the school, and also every time the student schedules an appointment with a tutor. All parent questions about the program will be directed to the school. At the beginning of the school year, a verification email is sent to the student in the school's database (within the app) to ensure the student still attends the school. The student must click on the Renew Account button in order to renew the account.

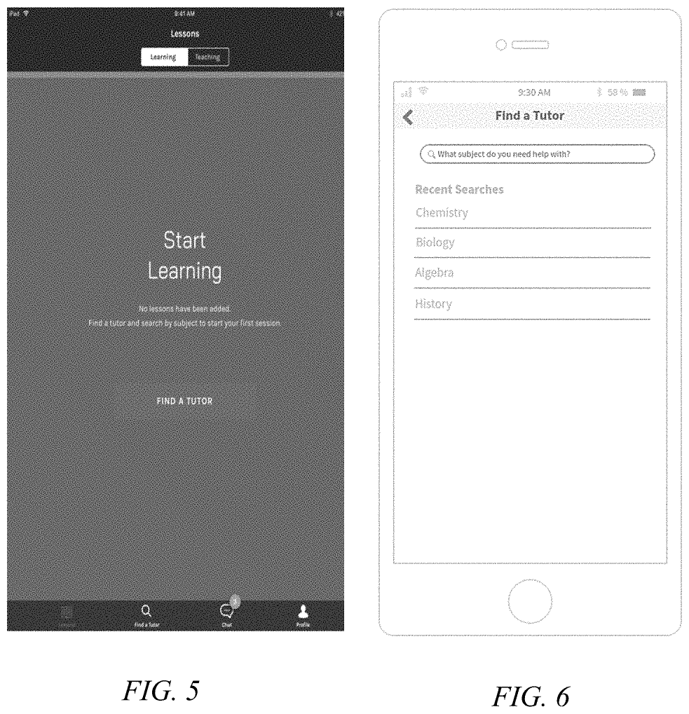

FIG. 5 shows a lessons page where the student is directed once the student activates the account. This example shows a lessons page with no lessons activated. This is what the student sees before an actual session has commenced. The page instructs the student to select a tutor in order to start a lesson. The main menu navigation will appear on most pages of the app at the bottom of the screen. In one embodiment as shown in FIG. 5, the navigation icons are: Lessons, Find a Tutor, Chat, Profile.

FIG. 6 shows a Find a Tutor page, including a list of any recent subjects searched for easy selection. The ten most recent searches are listed, with the most recent subject on top. The student can also search for a subject using the search bar. Smart search technology will present a drop-down once the user starts typing in a subject. The subjects are pulled from the database for that particular school even if there aren't any tutors currently available for that subject.

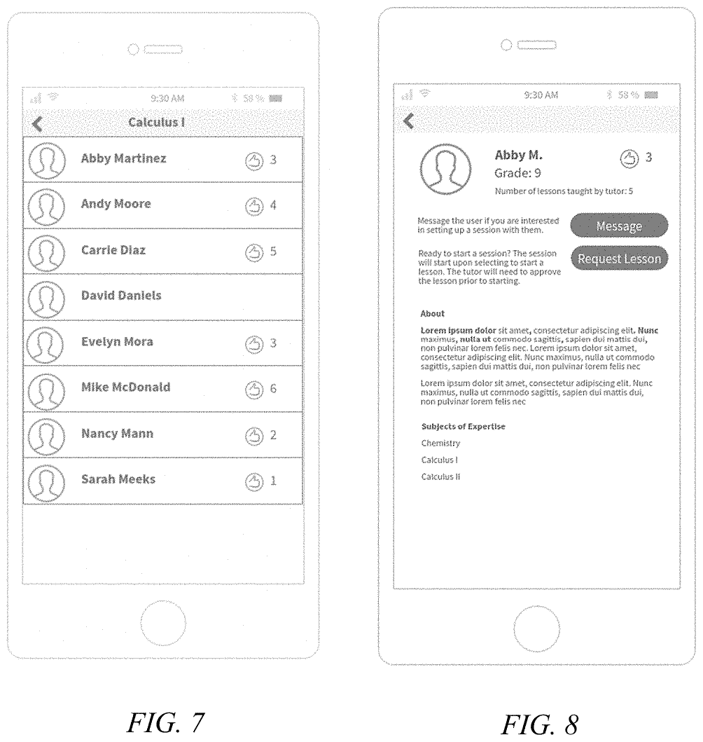

FIG. 7 shows a list of tutors for the selected subject. Only those tutors signed up to tutor in the chosen subject are shown. A tutor can be assigned to multiple subjects. Once a student selects a subject, the list of tutors (if available) is displayed.

FIG. 8 shows a tutor profile page. On this page the student has the option to either message the tutor directly or request a lesson. The profile has basic information about the tutor, as well as the tutor's current rating. The number of lessons taught is based on completed lessons only.

An email is sent to the student to rate the tutor. In one embodiment, the student rates the tutor by selecting a thumbs up or a thumbs down. In one embodiment, a thumbs down rating will not appear on the app. Students will see whether a tutor has had many successful tutoring sessions based on the positive feedback. There will be an email sent to the student requesting feedback. If the student reports a negative experience with the tutoring session, the student can email connect to the school administrator through the app to send a complaint.

Students from a particular grade will have the option to select students from other grades to be tutors. The app will not limit the student to only select tutors within the same grade. If the student has already started a message, but selects the message button from the tutor profile page, the thread from the conversation will appear on the page. Conversations will not be deleted. They will be archived after three months. If a student chooses to message a tutor the conversation thread will still appear, even after three months.

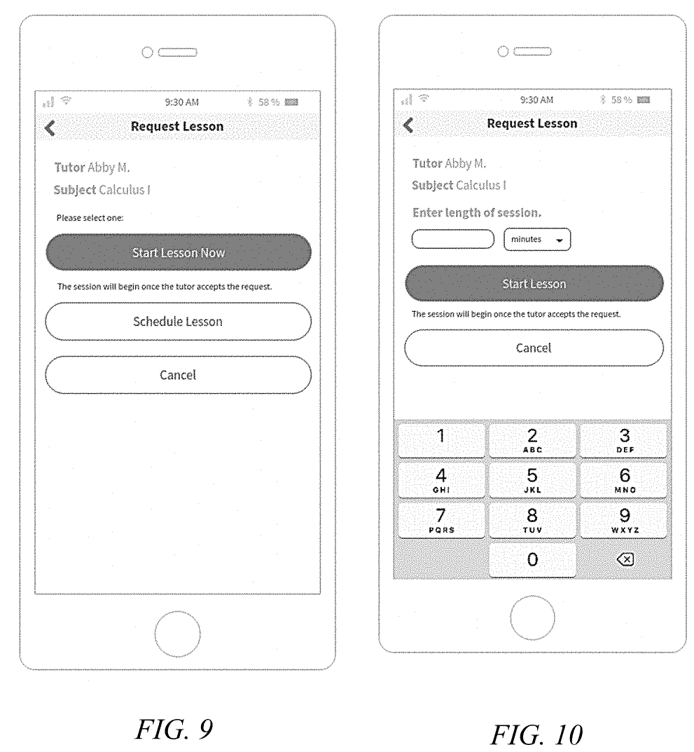

FIG. 9 shows a Request a Lesson page. The student has the option to select between starting a lesson now, scheduling a lesson at a later time, or canceling the request. The cancel button will direct the user back to the Lesson Page. The session begins once the tutor accepts the request. Three buttons are available for selection: Start Lesson Now, Schedule Lesson, or Cancel.

FIG. 10 shows an example of how the student can enter the desired length of the tutoring session. The student will enter the desired length of the lesson, in hours or minutes. The student can either start the lesson or cancel from this page. The cancel button directs the user back to the Lesson page (shown in FIG. 9). The start lesson button will be inactive until the student enters the lesson time. In one embodiment, a numeric keyboard appears once the student clicks on the time field. In another non-limiting embodiment, a scroll wheel allows the user to select time increments. Once the students clicks “Start Lesson” button, the lesson begins once the tutor accepts the request.

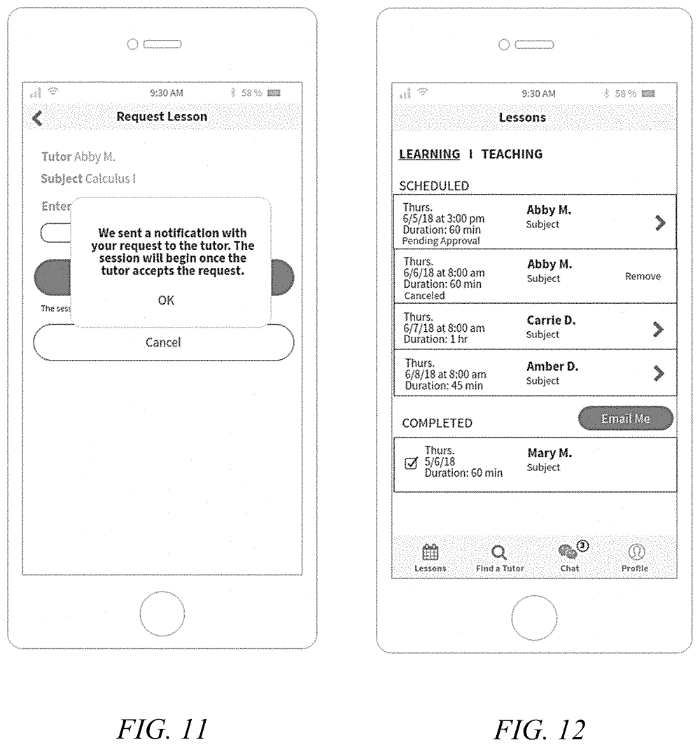

FIG. 11 Start Lesson—Request—once the student submits the request to start a lesson, a message is displayed notifying the student that the request has been sent. The OK button directs the user to the lesson page.

FIG. 12 shows a tutor's schedule. The tutor sessions that are scheduled to start now will be displayed under the Scheduled for Now category. The pending Approval note will be displayed until the request is approved. The arrow will direct the student to the detail page. An email option and a chat option are available from this screen.

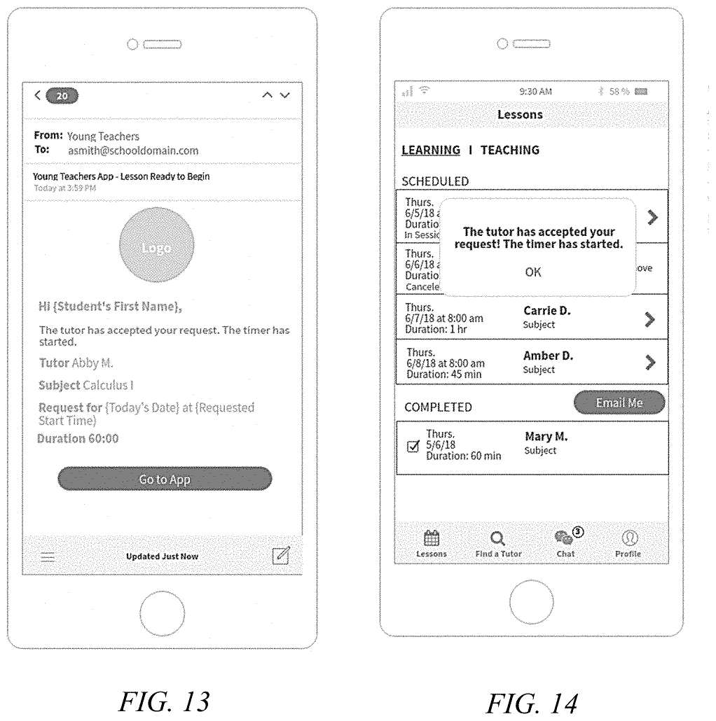

FIG. 13 shows the screen once the tutor has accepted the request. When the tutor accepts the request to start a tutoring session now, the student will receive the following notifying them that the tutor has accepted the request and the timer has started: email, notification (if app is not open), or pop-up window within app. The Go to App button will direct the student to the detail page where the countdown timer will be activated. The parent/guardian will receive the session email once both student and tutor are confirmed.

FIG. 14 shows a tutor approved request—a message appears notifying the student that the tutor has accepted the request and the timer has started. The note under the appointment will change from Pending Approval to In Session. The OK button will direct the user to the detail page where the time will be activated. If the app is closed, the user will receive a notification on their phone. Once a session is completed and under the Completed Session section, the student has the option to send the session information to their email. The session information can include the student name (or other identifier), the tutor name (or other identifier), the date/time, subject, and duration.

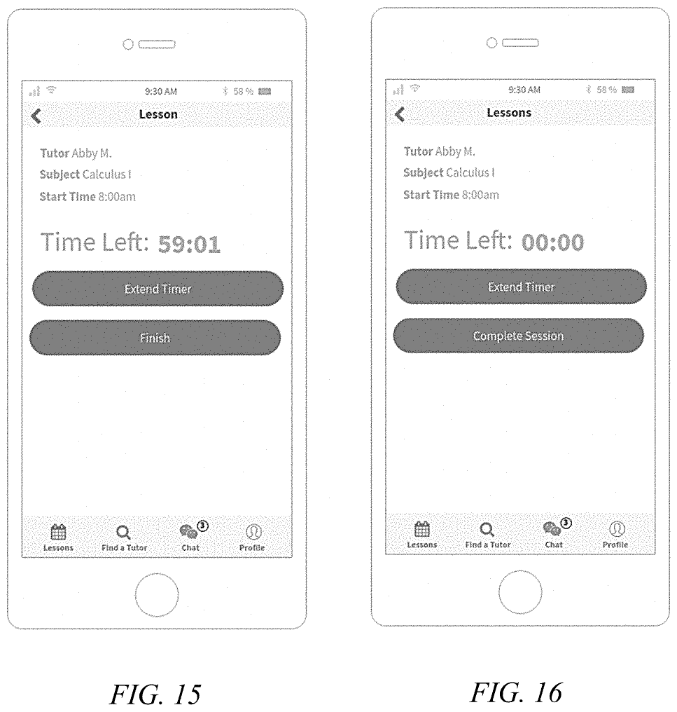

FIG. 15—time countdown. The timer will countdown until it reaches 00:00. The student will have the option to extend the timer, finish or cancel. If the timer is extended, the time will be added to the time left countdown and total duration for the session.

Referring to FIG. 16, once the timer hits zero, the student will have the option to extend the timer or complete the session. If the student selects to extend the timer, the timer option will appear on the page. The tutor has to approve the extension. If the student selects to complete the session, the lesson will be added to the lessons page.

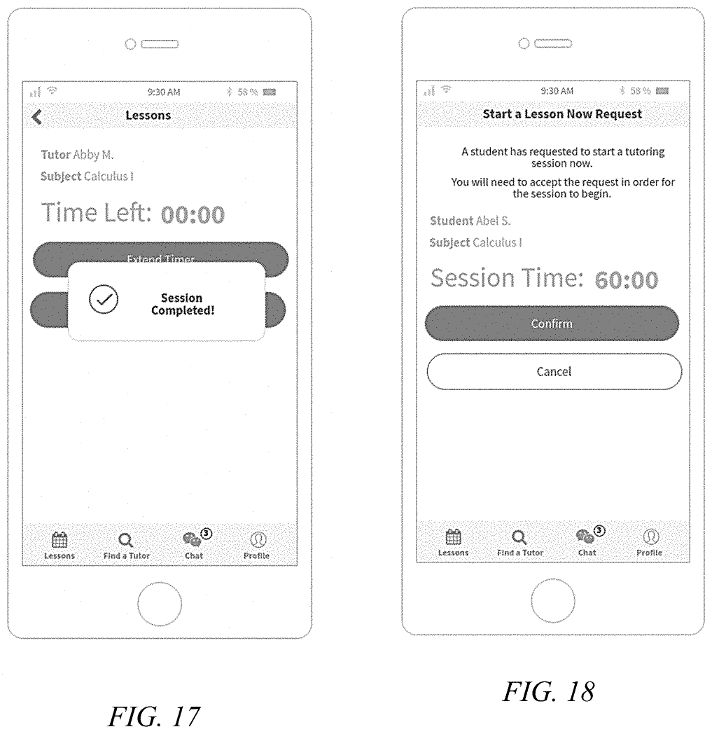

FIG. 17—Session completed. The Session Complete pop-up window will display on the page for five seconds. Once the five seconds are up, the student will be directed to the Lessons page. Then the student receives an email with the completed session information. A Go To App button directs the student to the Lessons page where the student can select another tutoring session. If the student requests another tutoring session, the tutor receives the request.

In FIG. 18 the session begins once the tutor accepts the request. If the app is closed, the tutor receives a notification. If the tutor selects cancel, a message appears to confirm if they would like to cancel the request.

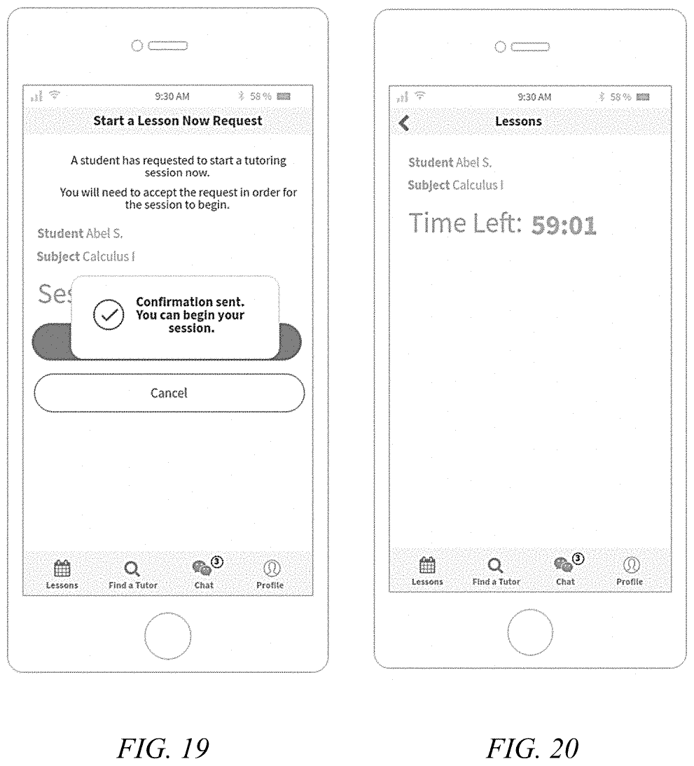

FIG. 19 shows a Tutor approval pop-up window. The pop-up window appears to notify the student that the tutor has approved the session. The pop-up window remains on the page for three seconds. Once the pop-up window disappears, the tutor is directed to the countdown page.

FIG. 20—Tutor Countdown page—the timer will count down until it reaches 00:00. The tutor will not be able to extend the time or finish the session. Only the student is able to control the length of the session.

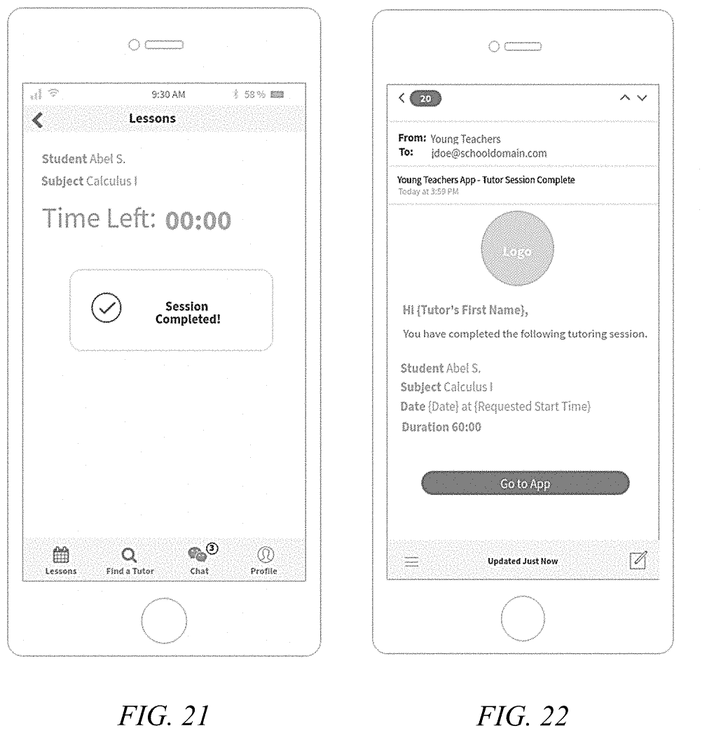

FIG. 21—Session Completed Pop-Up—Tutor—if the student selects Complete Session, a pop-up window will appear with a notification that the session is complete. The pop-up window remains on the page for three seconds. Once the pop-up window disappears, the student is directed to the Lessons page. If the student selects the “Complete Session” option, the session will appear under the completed category.

FIG. 22—Session complete Email—Tutor. If the student completes a tutoring session, the tutor will receive an email with the following information: Student name, subject, date, duration. The Go To App button will direct the student to the Lessons Page, in the event that the student wants to go to the app to either view the details, schedule another tutoring session and eventually email himself all of the tutoring sessions he/she has completed. If no lessons are added, the page instructs the student to select a tutor. This links to the Select a Subject Page, shown in FIG. 6.

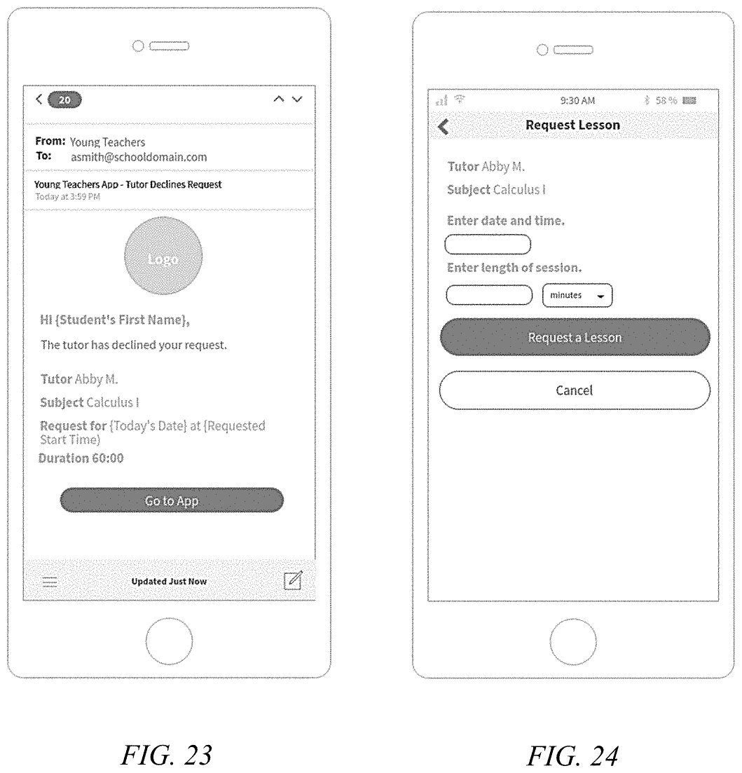

FIG. 23—tutor declines request page. If the tutor declines the request to start a tutoring session now, the student will receive the following notifying them that the tutor has declined the request: an email, a device notification/push notification (if app is closed), or pop-up window within app if the app is open. Then the “Go to App” button will direct the student to the Lessons page.

FIG. 24—Schedule Session for Later—The student has the ability to schedule a session for a later date. In this screen, the student enters the desired date, time, and length of the session. Then the student either requests the session or cancels. If canceled, the student is directed back to the Lesson Page (FIG. 5) The calendar/date selector that is native to the mobile device will appear if the student clicks on the date and time field. The Request a Lesson button remains inactive until the student adds the time.

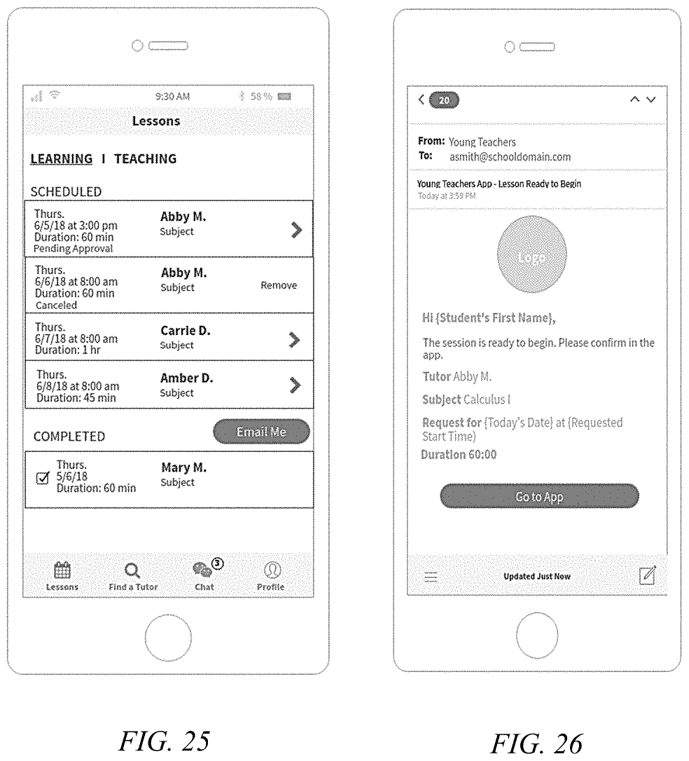

FIG. 25—Schedule Session for Later—Pending Approval Request. A pending approval note is displayed with the request until the request is approved (or rejected). The arrow directs the student to the Detail page. On the date and time scheduled for an approved session, the student will receive an email, a notification (if the app is closed), or a pop-up window within the app.

FIG. 26—Schedule Session Later—Session Ready to Begin Email to Student. The student will receive an email notifying that the session is ready to begin. The student receives the email on the date and time scheduled for the session. The system can also send a reminder prior to the start time for the lesson.

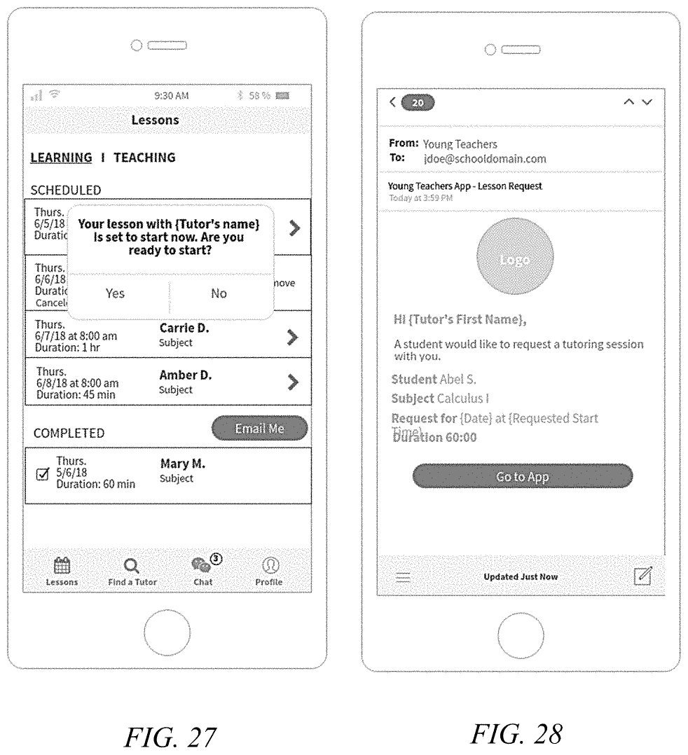

FIG. 27—Schedule Session later—Start Lesson Pop Up—a message will appear on the page notifying the student the lesson can begin. If “Yes,” the student is directed to the countdown page. If “No,” the student is directed to the Lessons page. The appointment remains on the page until it is cancelled. If the app is closed, the user receives a notification on their mobile device.

FIG. 28—Request email to Tutor—when a student requests a tutoring session the tutor receives a notification by: email (shown), notification (if app is closed), or pop-up window within the app. The “Go to App” button will link to the request page.

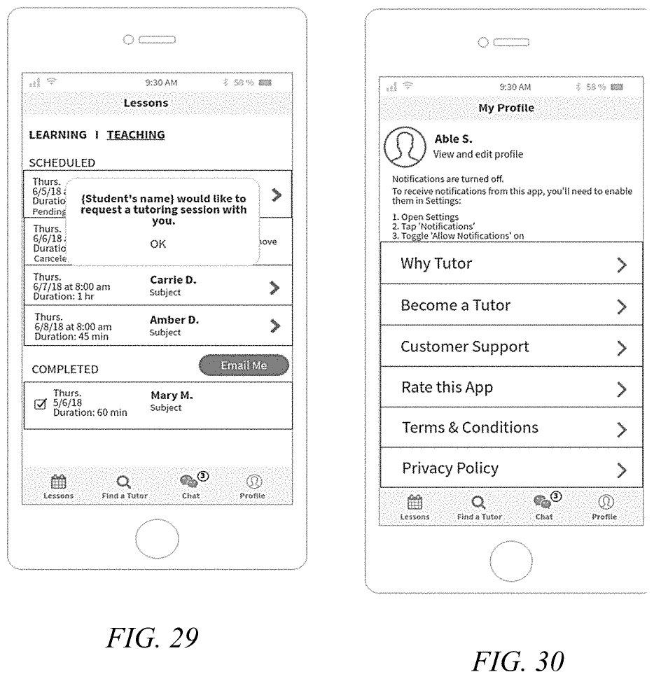

FIG. 29 shows the pop-up window that is displayed when a student requests a tutoring session.

FIG. 30 shows the Profile screen where a student can enter his/her information, such as name, address, grade, password and parent/guardian's contact information. The grade field is dynamic and controlled by the CMS.

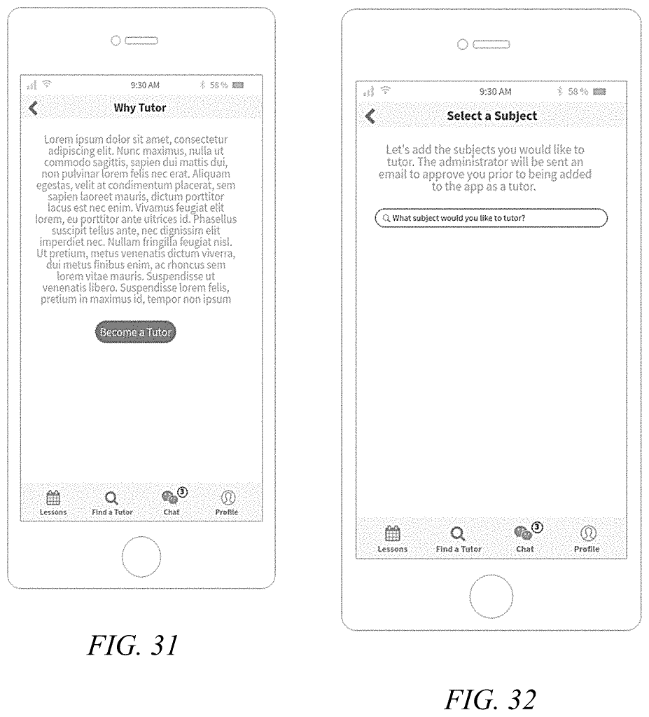

FIG. 31—Why Tutor—the Why Tutor page includes text as to why the student should tutor. It is customized per school and controlled by the administration. The Become a Tutor page links to this page.

FIG. 32—Become a Tutor—Select a Subject—the student needs to select a subject in which he/she desires to be a tutor. The Administrator has to approve this. Once the student submits the request to become a tutor, an email is sent to the administrator for approval. The student then receives an email either rejecting or approving. Once the subjects for tutoring are approved, the “Become a Tutor” button on the Profile Main page changes to “Tutor Profile.”

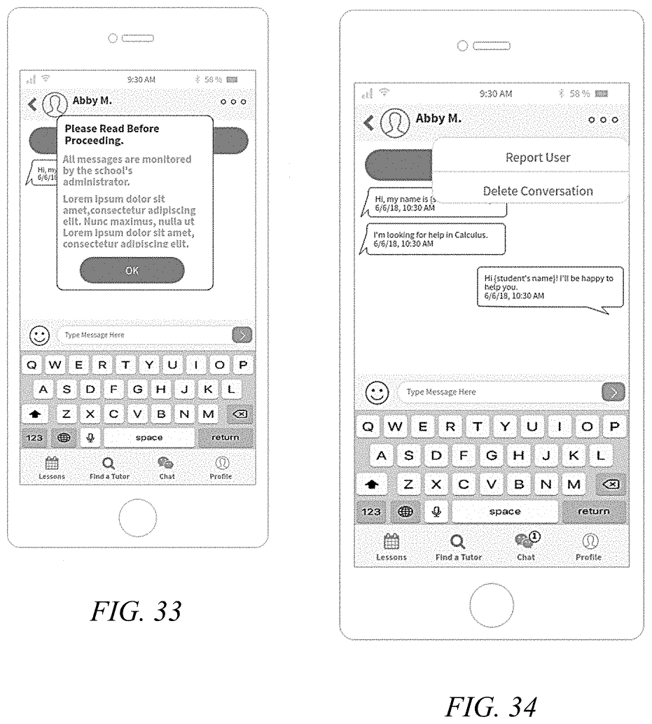

FIG. 33 shows the Chat with tutor—Monitoring Message screen. Before the student can message the tutor, a message is displayed stating that all messages are monitored. There will be an area in the CMS where a school/network administrator can view chats between the tutor and the student.

FIG. 34 shows the Chat with Tutor—More Buttons screen. In this screen, the “MORE” icon (three dots on the top right corner) will include the following options: “Report User,” “Delete Conversation.” The student can click on the MORE icon or outside of the action box in order to close the action box. If the user clicks on the Report User button, a pop-up window will appear asking the user to include a message as to why they are reporting the user. The report is sent via email to the admin and stored in the CMS. If the user clicks on the Delete Conversation button, a pop-up window appears asking the user to confirm they would like to delete the conversation. All conversations are stored in the CMS, whether they are “deleted” or not.

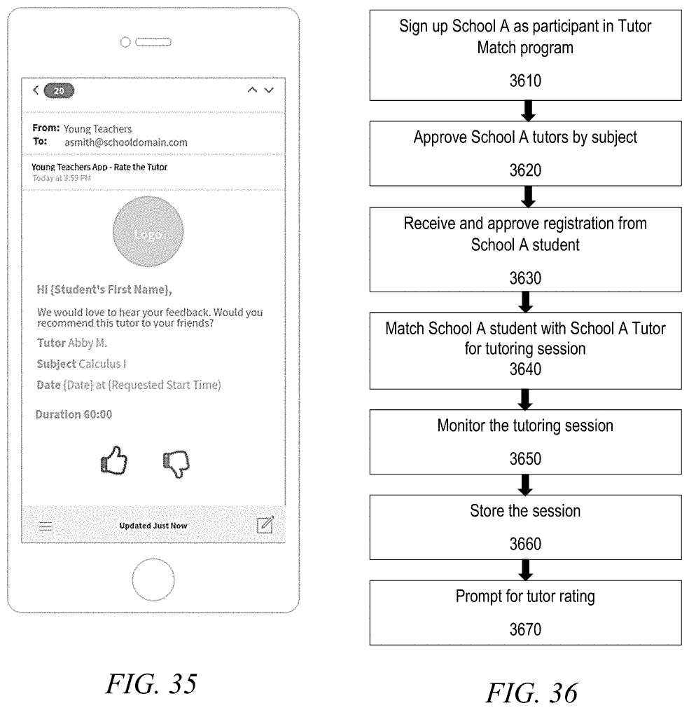

FIG. 35 shows the Rate Tutor screen. An email is sent to the student after the tutoring session asking the student to rate the tutor by selecting a thumbs up or a thumbs down.

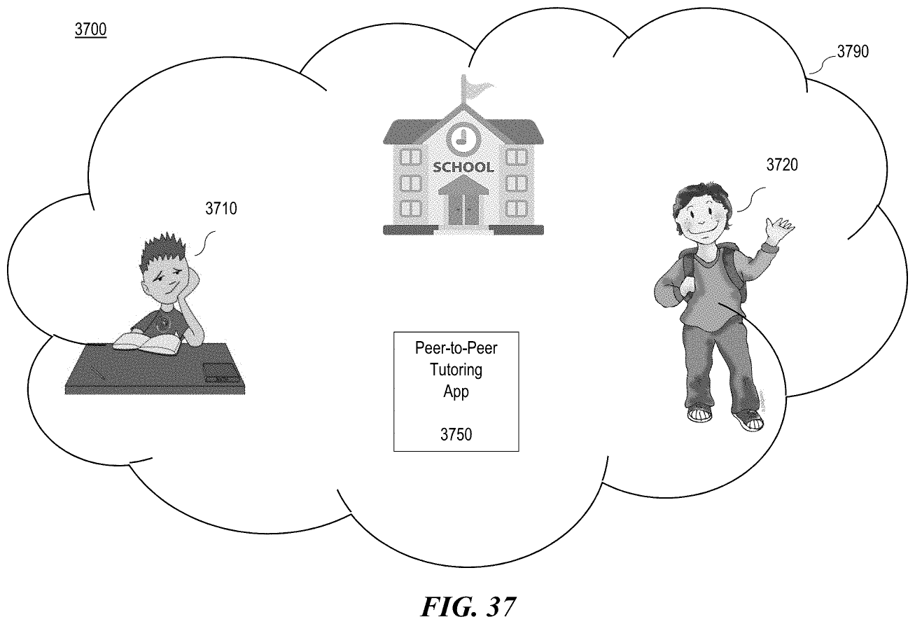

FIG. 37 shows a high-level simplified illustration of a system 3700 to match students with tutors in a closed network 3790. In one embodiment, the closed network is limited to a school domain. Access to the peer-to-peer tutoring application is limited to the school domain, as identified by email address. The network 3790 provides a secure environment wherein an entity such as a school 3704, students 3710, and tutors 3720 can interact through the peer-to-peer tutoring application 3750. The benefits of a closed social network are that it offers transparency and security at the same time. The school can monitor what is going on, yet the students and tutors are free to communicate directly with each other. In one embodiment, a Secure Sockets Layer (SSL) is used to establish secure connections between the web services and the clients.

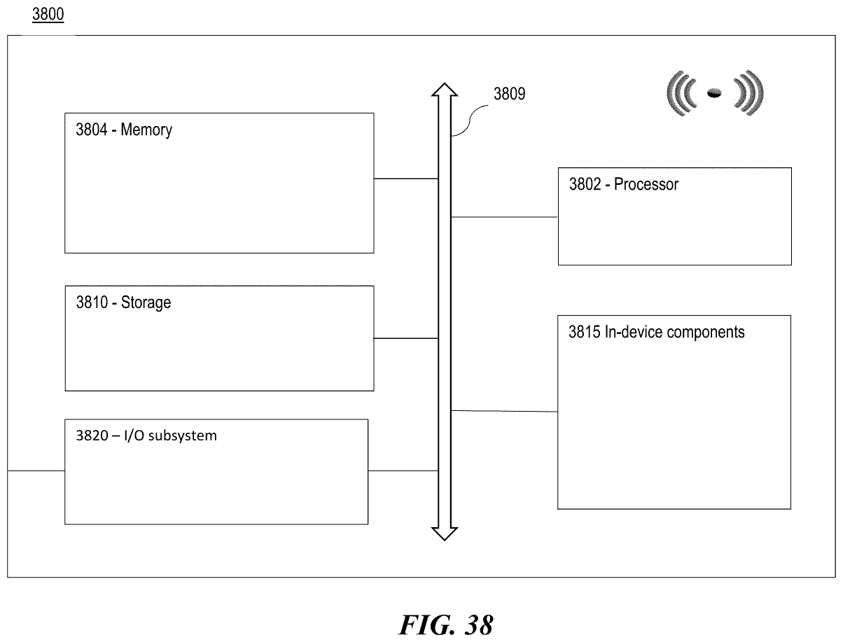

FIG. 38 shows a high-level simplified block diagram of the components for a client device 3800, according to an embodiment. The client device 3800 is any type of mobile programmable electronic device, such as a smartphone, wearable computing device, tablet computer, personal digital assistant, tablet, laptop computer, and the like. The client device 3800 includes inter alia: a processing device 3802 coupled with memory 3804, storage 3810, and in-device feature components 3815 such as a camera and GPS, all operatively linked by bus 3809. An input/output (I/O) subsystem 3820 controls a user interface. One with knowledge in the art will appreciate that other components will be included in order to operate a commercially feasible device; however, those are not depicted herein for simplicity and clarity of illustration.

The client device 3800, operates a Mobile Operating System (OS), which can be a proprietary OS developed and sold by a provider, such as iOS developed by Apple Inc., and Android OS developed by Google. The Mobile OS contains operating system features, in addition to other features common to smartphones, such as GPS, camera, music player, Bluetooth, stopwatch, alarm, calendar, and the like. The Mobile OS will also include various apps, some of which are supplied ‘out of the box’ (included with the device), and some of which are later acquired by the user. Future marketing and development will direct the manner in which the peer-to-peer tutoring app will be provided (download or otherwise). The user interface controls how the user is able to interact with the device, controlling such things as touch screens, keyboards, swipes, icon views, and the like.

Underlying Technology.

In one non-limiting example, the peer-to-peer tutoring app is a native app run on cell phones and tablets, such as the Apple iPhone® and Apple iPad®. A native Android version will run on Android phones and tablets. In one embodiment, the server side functionality and data is held in AWS (Amazon Web Services) and served to the mobile app via API, accessed either by cellular network or WiFi. Some 3rd party services used: Apple Push Notification services, Google Firebase for the real-time database implementation for the chat functionality.

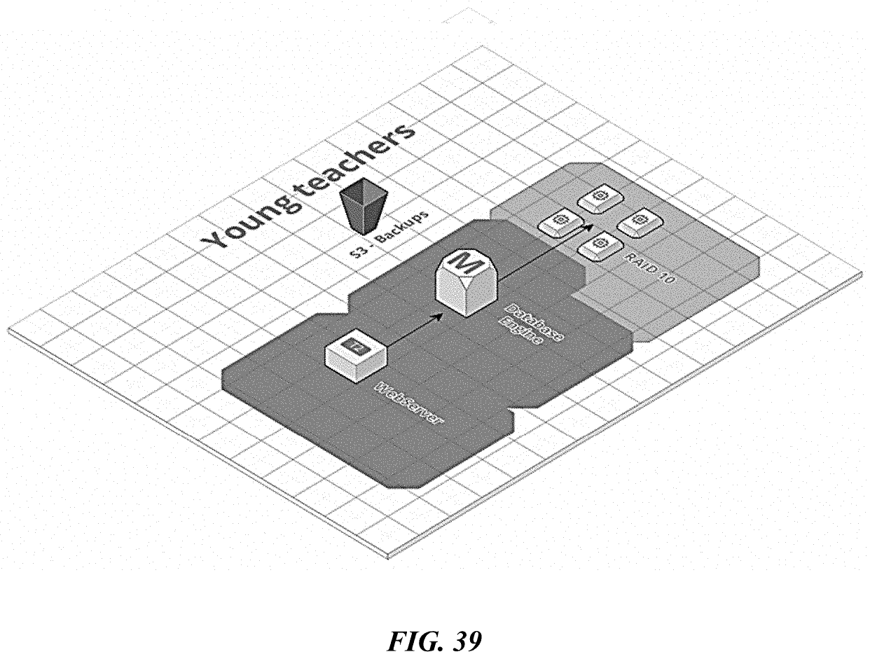

FIG. 39 shows an example of a Server infrastructure. The Webserver uses Docker (Docker-compose), ExpressJS for frontend and NodeJS for backend development. SSL is used to establish secure connections between the web servers and the client (mobile app). The web server is behind an HAProxy load balancer. The Database server runs MongoDB on RAID 1 to disk setup. System backups are done using AWS 33.

The use of this technology hopes to create greater connections among the student body. Most technology being used by schools today are done by the individual student and the technology (i.e., computer, tablet, etc.). In researching behavior in young adults, students enjoy learning and learn more efficiently through collaboration.

While the invention as claimed can be modified into alternative forms, specific embodiments thereof are disclosed herein by way of example. It should be understood, however, that the foregoing disclosure is not intended to limit the invention to the particular form disclosed, but on the contrary, the intention is to cover all modifications, equivalents and alternatives falling within the scope of the present disclosure.

Further, in view of many embodiments to which the principles of the invention may be applied, it should be understood that the illustrated embodiments are exemplary embodiments and should not limit the present disclosure. Modules or components from one embodiment can be used with another embodiment.

Therefore, while there has been described what is presently considered to be the preferred embodiment, it will be understood by those skilled in the art that other modifications can be made within the spirit of the disclosure. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

1. A system to match students with tutors in a closed network, the system comprising:
an electronic communications network;
a school domain configured to be accessible via the electronic communications network and secured to allow only authorized users to access said school domain; and
a peer-to-peer tutoring application, the operation of which is limited to within the school domain, configured to interact with a school, a one or more student of the school, and a one or more tutor of the school.

2. A computer-implemented method to facilitate peer-to-peer tutoring within a closed network, the computer-implemented method comprising:
providing an application with a graphical user interface on a client device associated with a student, the application facilitating peer-to-peer tutoring between the student and a tutor, wherein the student and the tutor are both registered in the closed network;
receiving a search request from the student for a specific subject of instruction for a specific grade level;
returning results comprising a profile of at least one tutor that has been pre-qualified in the specific subject of instruction at the specific grade level, wherein the profile comprises contact information for the at least one tutor;
receiving from the student a selection of the tutor;
monitoring a chat between the student and the tutor, wherein the student and the tutor agree on a tutoring session at a specific time;
monitoring each interaction between the student and the tutor;
notifying the student's parent/guardian of each tutoring event;
recording start and stop times of the tutoring session; and
sending a report about the tutoring session to an administrator of the closed network.

3. The computer-implemented method of claim 2 wherein the tutor is also a student.

4. The computer-implemented method of claim 2 further comprising interfacing with in-device features of the client device during the tutoring session.

5. The computer-implemented method of claim 4 wherein interfacing with the in-device features comprises recording the tutoring session with an in-device recorder.

6. The computer-implemented method of 4 further comprising scheduling a tutoring session using an in-device calendar function.

7. The computer-implemented method of claim 4 further comprising identifying students and tutors who are in proximity by accessing the in-device features of their mobile devices.

8. The computer-implemented method of claim 2 further comprising restricting interaction between the student and the tutor until both are validated.

9. The computer-implemented method of claim 2 wherein the tutoring session is a distance learning session using video conference technology.

10. The computer-implemented method of claim 2 further comprising logging community service hours for the tutor at the end of the tutoring session.
